(19) United States
(12) Patent Application Publication
(10) Pub. No.: US 2019/0348877 A1
(43) Pub. Date: Nov. 14, 2019

(54) ELECTRIC WORK MACHINE

(71) Applicant: MAKITA CORPORATION, Anjo-Shi (JP)

(72) Inventors: Kei KOUDA, Anjo·shi (JP); Hong ZHANG, Anjo·shi (JP)

(21) Appl. No.: 16/381,272

(22) Filed: Apr. 11, 2019

(30) Foreign Application Priority Data
May 8, 2018 (JP) 2018-090127

(51) Int. Cl. H02K 1/27

(52) U.S. Cl. CPC H02K 1/276; A01D 2101/00

(57) ABSTRACT

A motor (20) for use, e.g., in a lawn mower (1) includes a rotor (52), which has a circular-columnar shape and is rotatable about its axis. The rotor (52) includes a plurality of plate-shaped permanent magnets (172) and a rotor core (170), which has a circular-columnar shape and has a plurality of magnet holes (171) into which the permanent magnets (172) are respectively inserted such that the permanent magnets (172) extend in an axial direction and a circumferential direction of the rotor (52). Each magnet hole (171) is formed such that an aperture (174b, 274b, 374) directly-faces or adjoins a radially outer-side surface (172a) or a radially inner-side surface (172b) of the corresponding inserted permanent magnet (172).

### CROSS-REFERENCE

The present application claims priority to Japanese patent application serial number 2018-090127 filed on May 8, 2018, the contents of which are incorporated fully herein by reference.

### TECHNICAL FIELD

The present teachings relate to electric motors for use, e.g., in electric work machines, such as power tools, gardening tools (e.g., lawn mowers and other types of outdoor power equipment), air compressors for pneumatic tools, and the like.

### BACKGROUND ART

Japanese Patent No. 4110146 and its counterpart US patent publication no. 2009/0152972 A1 disclose a rotor 100 of an electric motor having gaps 31, 32 in ends 21, 22, respectively, of a plurality of field-magnet through holes 2, into which plate-shaped field magnets 6 are inserted.

Each gap 31 extends outward in a circumferential direction from a radial-direction surface of an end part of the corresponding field magnet 6 (third portion 313), then extends in the radial direction (second portion 312), and further extends in the circumferential direction so as to return to the side of the field magnet 6 (first portion 311). The first portion 311 is spaced apart from a circumferentially-extending surface of the field magnet 6.

The gaps 32 are formed in the same manner as the gaps 31.

The entirety of the circumferentially-extending surfaces of each field magnet 6 contact the circumferentially-extending surfaces of the corresponding field-magnet through hole 2.

### SUMMARY OF THE INVENTION

Typically, a magnet is fixed to (in) a through hole of a rotor by filling the through hole with an adhesive or a resin; if the above-mentioned rotor 100 is manufactured in this manner, even though the adhesive, resin, etc. will flow in the gaps 31, 32, the adhesive, resin, etc. will tend not to flow to other portions.

The gaps 31, 32 are spaced apart from the circumferentially-extending surfaces of the field magnets 6, and thus a limit on the orientation of the magnetic fluxes of the field magnets 6 exists.

Therefore, one non-limiting object of the present teachings is to provide an electric work machine comprising a motor in which a through hole of a rotor can be easily filled with an adhesive, a resin, etc. and consequently a magnet can be robustly fixed to (in) the through hole.

Another non-limiting object of the present teachings is to provide an electric work machine comprising a motor in which the directionality of the magnetic fluxes of the magnets are suitably modified, so that the motor can be efficiently driven.

Additional objects of the present teachings will become apparent upon reading the following description of embodiments of the present teachings.

In a first aspect of the present teachings, a motor preferably comprises a rotor, which has a columnar or a tube shape and is rotatable about its axis. The rotor preferably comprises: a plurality of plate-shaped permanent magnets; a rotor core, which is columnar or tubular and has a plurality of magnet holes into which the permanent magnets are inserted such that the permanent magnets extend in an axial direction and a circumferential direction; and bonding material, which bonds the magnet holes and the permanent magnets inserted into those magnet holes. At least one of the magnet holes is formed such that one or more apertures is (are) created against (directly facing, adjoining) a radially outer-side (outward) surface and/or against (directly facing, adjoining) a radially inner-side (inward) surface of the corresponding inserted permanent magnet.

In a second aspect of the present teachings, a motor preferably comprises a rotor, which has a columnar or a tube shape and is rotatable about its axis. The rotor comprises: a plurality of plate-shaped permanent magnets and a rotor core, which is columnar or tubular and has a plurality of magnet holes into which the permanent magnets are inserted such that the permanent magnets extend in an axial direction and a circumferential direction. At least one of the magnet holes is formed such that one or more apertures is (are) created against (directly facing, adjoining) a radially outer-side (outward) surface of the corresponding inserted permanent magnet.

In a third aspect of the present teachings, the aperture(s) is (are) disposed such that it is (they are) adjacent to (adjoining) a circumferentially-extending end portion of the permanent magnet (an end portion of a long side of the permanent magnet in the circumferential direction thereof).

In a fourth aspect of the present teachings, the aperture(s) has (have) a groove shape.

In a fifth aspect of the present teachings, the aperture(s) extend(s) in the axial direction of the rotor core and penetrate(s) through the rotor core.

In a sixth aspect of the present teachings, at least one of the magnet holes is formed such that an end-portion aperture, which is located against (directly faces, adjoins) an end surface of the corresponding inserted permanent magnet in the circumferential direction, is additionally created; and one of the above-mentioned aperture(s) is in series with the above-mentioned end-portion aperture.

One non-limiting effect of the present teachings is that an electric work machine is provided that comprises a motor in which a through hole of a rotor can be easily filled with an adhesive or a resin such that a magnet can be robustly fixed to the through hole.

In addition or in the alternative, another non-limiting effect of the present teachings is that an electric work machine is provided that comprises a motor in which the directionality of the magnetic fluxes of the magnets has been suitably modified, so that the motor can be efficiently driven.

### BRIEF DESCRIPTION OF THE DRAWINGS

FIG. 1 is a center longitudinal-cross-sectional view of a lawn mower according to a first embodiment of the present teachings.

FIG. 2 is a partial, enlarged view of FIG. 1.

FIG. 3 is an oblique view of the motor in the lawn mower shown in FIG. 1.

FIG. 4 is a center longitudinal-cross-sectional view of the motor shown in FIG. 3.

FIG. 5 is a center transverse-cross-sectional view of the motor shown in FIG. 3.

FIG. 6 is a partial, enlarged view of a rotor and stator core in the motor shown in FIG. 3.

FIG. 7 is a view that shows, according to the motor shown in FIG. 3, schematic magnetic-flux lines and the magnitude (color darkness) of magnetic-flux density at the instant when four teeth, one each on the front, rear, left, and right, and every other permanent magnet oppose one another.

FIG. 8 is a view that shows, in a comparative example wherein flux barriers are not provided with outer-circumference side parts, schematic magnetic-flux lines and the magnitude of magnetic-flux density.

FIG. 9 is a view, corresponding to FIG. 5, of the motor of a lawn mower according to a second embodiment of the present teachings.

FIG. 10 is a view, corresponding to FIG. 6, of the motor of a lawn mower according to the second embodiment of the present teachings.

FIG. 11 is a view that shows schematic magnetic-flux lines and the magnitude of magnetic-flux density in the motor of the lawn mower according to the second embodiment of the present teachings.

FIG. 12 is a center transverse-cross-sectional view of the rotor of a motor in a lawn mower according to a third embodiment of the present teachings.

### DETAILED DESCRIPTION OF EMBODIMENTS

Embodiments and their modified examples of the present teachings are explained below, with reference to the drawings as appropriate.

Front, rear, up, down, left, and right in the embodiments and the modified examples are prescribed for the sake of convenience of the explanation and may change depending on the state of the work, the state of members that move, and the like.

It is noted that the present teachings are not limited to the embodiments and modified examples described below.

### First Embodiment

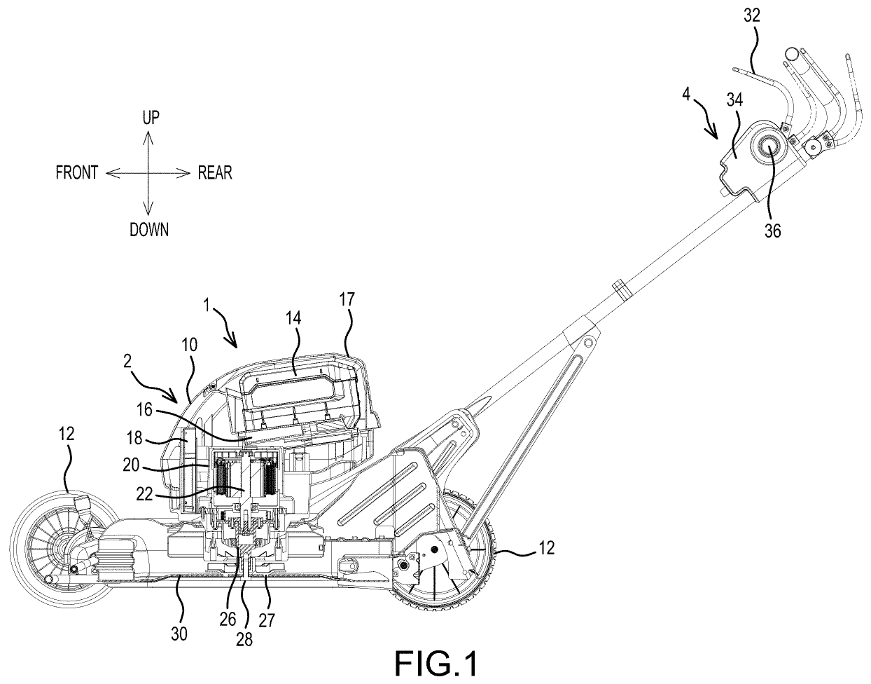

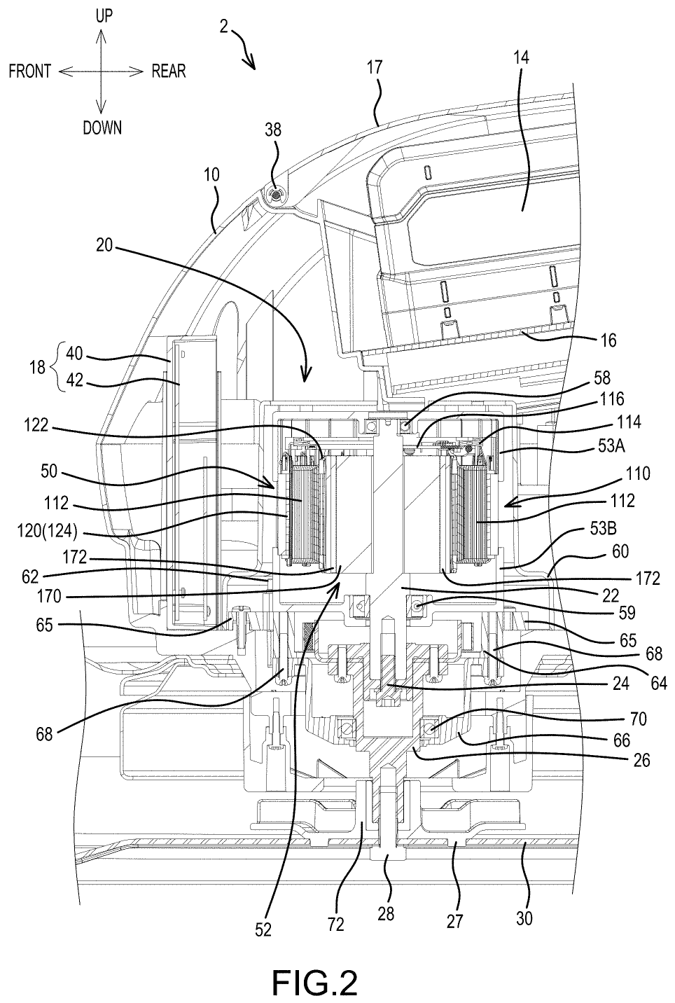

FIG. 1 is a center longitudinal-cross-sectional view of a rechargeable lawn mower 1, which is one representative, non-limiting example of an electric work machine (e.g., a gardening tool or outdoor power equipment) according to a first embodiment of the present teachings. FIG. 2 is a partial, enlarged view of FIG. 1.

The lawn mower 1 comprises a main body 2 and a frame-type handle 4, which extends rearward and diagonally upward from the rear part of the main body 2. It is noted that directions are based on a user who grasps the handle 4, and thus left in FIG. 1 is frontward of the lawn mower 1, and up in FIG. 1 is upward of the lawn mower 1.

The main body 2 comprises: a box-shaped main body housing 10, which directly or indirectly holds various members and is open downward; wheels 12, which are rotatably disposed at the four corners of the main body housing 10; a battery-mounting part 16, which is formed on an upper part of the main body housing 10 and onto which one or two battery packs 14 are mountable; a battery cover 17, which covers the battery-mounting part 16 and the battery pack(s) 14 mounted thereon; a flat, box-shaped controller 18, which is held such that it extends upward, downward, leftward, and rightward inside a front part of the main body housing 10; a motor 20, which is held by a center part inside the main body housing 10; a spindle 26, which is coupled via a bolt 24 to a motor shaft 22 of the motor 20 facing downward, extends upward and downward, and serves as an output shaft; and a horizontal, plate-shaped cutting blade 30 (tool accessory), which is coupled to a lower part of the spindle 26 via a horizontal, ring-shaped inner flange 27 and a bolt 28 extending upward and downward.

The motor shaft 22, the bolt 24, the spindle 26, the inner flange 27, the bolt 28, and the cutting blade 30 are coaxial. It is noted that a speed-reducing mechanism, a speed-increasing mechanism, or a motive-power-direction converting mechanism may be operably disposed between the motor shaft 22 and the cutting blade 30; either the motor shaft 22 or the cutting blade 30, or both, need not be disposed coaxially with the other members. In addition, the spindle 26 may be omitted. The spindle 26 or the cutting blade 30, or both, may be coupled by a means (fastener) other than a bolt.

A switch lever 32, which is L-shaped in side view and U-shaped in rear view, is provided, in a manner capable of being pulled by the user (rotatable about its axis in the left-right direction), on the handle 4 via left and right lever-coupling parts 34.

In addition, a lock-off button 36, which is pullable by the user, is provided on an inner surface side of the right lever-coupling part 34 and protrudes inward from that inner surface.

When the user presses the lock-off button 36, the switch lever 32 becomes pullable. If the user stops pulling the switch lever 32, the switch lever 32 returns frontward to the pull-operation disabled state as long as the lock-off button 36 is not being pressed. The lock-off button 36 is latched to the switch lever 32 when it is not pulled, and that latching is released by the movement of the switch lever 32 when it is pulled.

The battery-mounting part 16 of the main body 2 has a mounting surface that is tilted downward toward the front, and the battery pack(s) 14 is (are) mounted, by sliding it (them) frontward from the rear side, onto at least one of a left part and a right part of the mounting surface. It is noted that the mounting surface may be tilted upward toward the front or may be horizontal. In addition, one or three or more of the battery packs 14 may be mounted on the battery-mounting part 16. Furthermore, the sliding direction of the battery pack 14 may be rearward, the left-right direction, or the like. The battery pack 14 may be mounted by a method other than sliding, such as by being inserted into a battery case from above.

Referring now to FIG. 2, a shaft 38 extends in the left-right direction and is passed through a front part of the battery cover 17. The shaft 38 is supported by an upper part of the main body housing 10. The battery cover 17 is rotatable about the shaft 38 relative to the main body housing 10; if the battery cover 17 is rotated upward from the position at which it covers the battery-mounting part 16, then the battery-mounting part 16 or the battery pack(s) 14 is (are) exposed and thereby the battery pack(s) 14 can be mounted and dismounted.

The controller 18 comprises: a controller case 40, which is open rearward and has a flat box shape; and a control circuit board 42, which is held in an inward part thereof and extends upward, downward, leftward, and rightward.

The controller 18 (the control circuit board 42) is connected to a mounting-part side terminal (not shown), which is disposed on the battery-mounting part 16, by a lead wire (a power-supply line), which is not shown. The mounting-part side terminal connects to a battery-side terminal (not shown) of the mounted battery pack 14.

In addition, a microcontroller (not shown) and a plurality of (e.g., six) switching devices (not shown) for controlling the motor 20 and the like are mounted on the controller 18 (the control circuit board 42).

Furthermore, the controller 18 (the control circuit board 42) is connected to a main switch (not shown), which is connected to and switched by the switch lever 32, by a lead wire (a switch-signal wire), which is not shown.

It is noted that the controller 18 (the control circuit board 42) may control only the motor 20. In addition, the controller 18 (the control circuit board 42) may be electrically connected to a lock switch that is connected to the lock-off button 36. In this case, if the lock switch is not in a switch state corresponding to the pressing of the lock-off button 36, then the motor 20 cannot be rotated even if the main switch is ON.

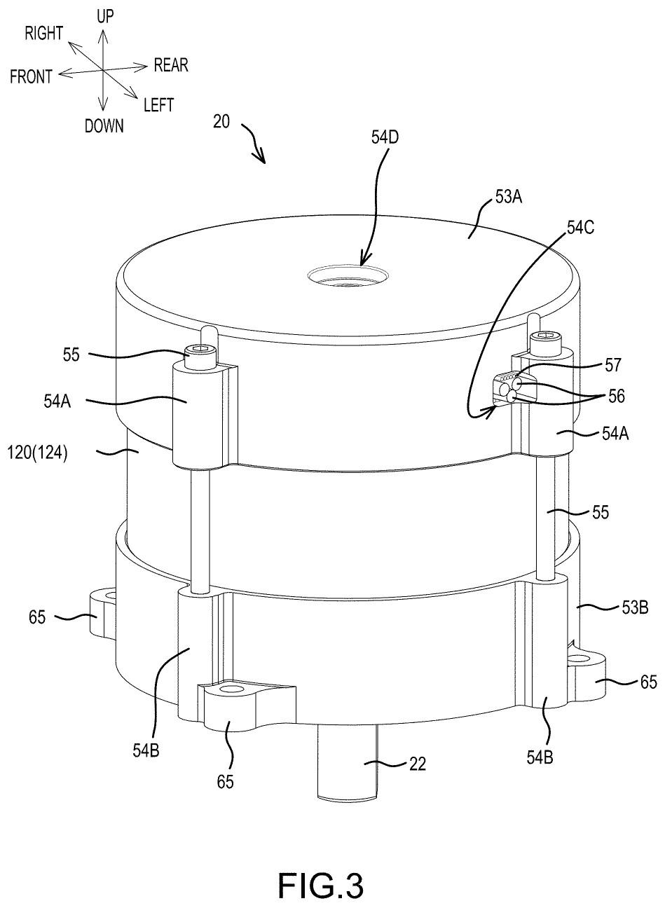

The motor 20, which is shown also in FIG. 3 to FIG. 6, is a brushless motor and is a DC (rechargeable) motor that is driven with current provided by the battery pack(s) 14. The motor 20 is an inner-rotor type and comprises a tubular stator 50, whose axial direction is in the up-down direction, and a circular-column-shaped rotor 52, which is disposed in the interior of the stator 50 and is rotatable with respect to the stator 50. It is noted that the motor 20 optionally may be a brushed motor and/or may be an outer-rotor type in which a tubular rotor is disposed on an outer side of a columnar stator. In addition, the motor 20 optionally may be an AC (alternating current) motor instead of a DC motor. Furthermore, the rotor 52 may have a circular-cylindrical shape, may have a prism shape or a polygonal-tube shape, or may have some other shape.

Referring now to FIG. 3, the stator 50 is covered from above and below by a circular-cylindrical-shaped upper motor cover 53A and a circular-cylindrical-shaped lower motor cover 53B, respectively. The upper motor cover 53A is provided with a plurality of (e.g., three) upper protruding parts 54A, which protrude in the radial direction with respect to other portions such that they are equispaced in the circumferential direction. In addition, the lower motor cover 53B comprises lower protruding parts 54B, which are similar to the upper protruding parts 54A. Furthermore, the upper motor cover 53A and the lower motor cover 53B are spaced apart and coupled to one another by passing a plurality of (e.g., three) bolts 55, which extend in the up-down direction, through the upper protruding parts 54A and the lower protruding parts 54B that oppose one another. A plurality of (e.g., three) power-supply lines 56 and a plurality of (e.g., six) signal lines 57 lead out from a hole 54C, which is provided in a side surface of the upper motor cover 53A. The motor 20 is electrically connected to the controller 18 (the control circuit board 42) via the power-supply lines 56 and the signal lines 57.

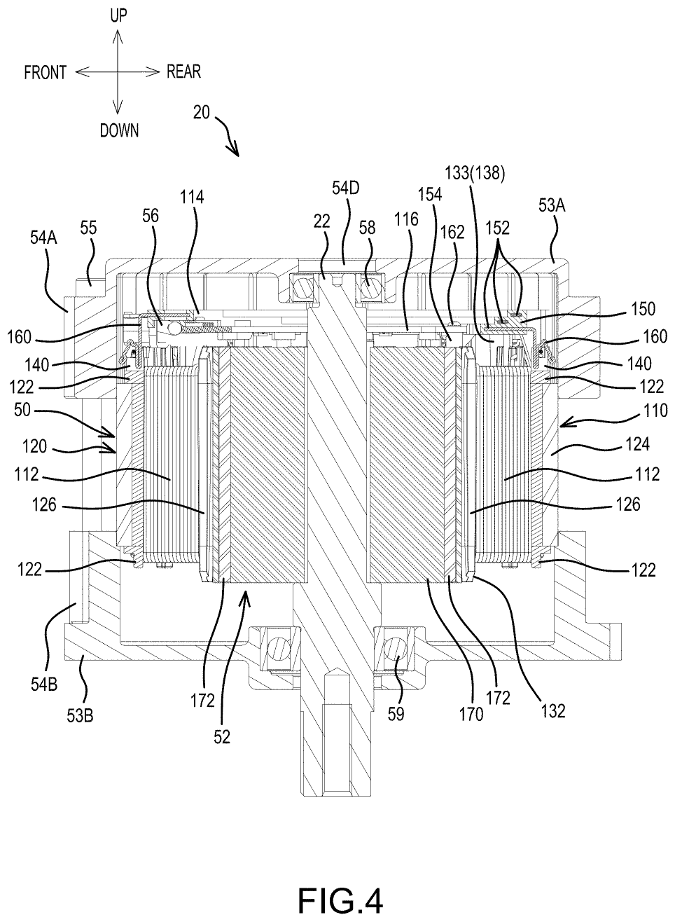

Referring now to FIGS. 2 and 4, the rotor 52 comprises a motor shaft 22, which is disposed in the up-down direction along the axial center of the rotor 52. A lower end of the motor shaft 22 is exposed at the lower side of the lower motor cover 53B and an inner part of the lower end of the motor shaft 22 has a hole for the bolt 24.

An upper bearing 58, which rotatably supports the motor shaft 22 about its axis, is held inside the upper motor cover 53A. A hole 54D, which is for cooling the motor shaft 22, is formed in a portion that is located on an upper side of the bearing 58 and is an upper part of the upper motor cover 53A.

A lower bearing 59, which rotatably supports the motor shaft 22 about its axis, is held inside the lower motor cover 53B.

The motor 20 is held by: a motor housing 60, which is open downward, has a bowl shape, and is held inside the main body housing 10; and a motor-housing cover 64, which is disposed in a lower end of the motor housing 60 and is held on the main body housing 10 by a plurality of screws 62. Screw holes 65, through which the screws 62 respectively pass, are provided on the left and right of the front and the left and right of the rear of the lower motor cover 53B such that the screw holes 65 extend radially outward.

A spindle housing 66, which is open upward and has a bowl shape, is held on a lower part of the motor-housing cover 64 via a plurality of screws 68.

The spindle housing 66 holds, in the center inside a lower part, a spindle bearing 70, which rotatably supports the spindle 26.

A lower end of the spindle 26 is exposed on the lower side of the spindle housing 66, and an inner part of the lower end of the spindle 26 has a hole for the bolt 28.

The cutting blade 30 is sandwiched between the inner flange 27 and the bolt 28.

A circular-cylindrical-shaped projection 72 is formed on an upper surface of the inner flange 27. The circular (annular) projection 72 receives the tip of the spindle 26.

Furthermore, the stator 50 of the motor 20 comprises a stator-core assembly 110, a plurality of (e.g., twelve) coils 112, a terminal unit 114, and a sensor circuit board 116.

The stator-core assembly 110 comprises: a stator core 120; and an insulator 122, which is disposed above, below, and on the inner side of the stator core 120 and is held by the stator core 120.

The stator core 120 is a laminated body in which a plurality of ring-shaped steel plates is laminated, and an inner-circumferential part of a circular-cylindrical part 124 has (e.g., twelve) teeth 126, which project radially inward and are arranged equispaced in the circumferential direction.

The tip of each tooth 126 on the radial inner side extends both in the up-down direction and the circumferential direction with respect to other portions, and the tip surface has a shape that bulges radially inward, i.e. toward the center of the stator core 120.

A space (a slot), in which two of the coils 112 are disposed, is located between each pair of circumferentially-adjacent teeth 126.

The insulator 122 is a tubular, electrically-insulating part made of resin and comprises tooth-covering parts 132, which are disposed on the outer sides of the teeth 126, and a circular-tubular part 133, which connects the tooth-covering parts 132 and extends upward and downward in a ring shape. It is noted that, in FIG. 4, the insulator 122 and the stator core 120 are illustrated collectively as a stator-core assembly 110.

Each tooth-covering part 132 covers its corresponding tooth 126 except for the tip.

In addition, a plurality of (e.g., five) screw bosses 138, each screw boss 138 having a screw hole in the up-down direction, is formed on an upper part of the circular-tubular part 133. The screw bosses 138 are arranged equispaced in the circumferential direction such that they are located at five vertices of a virtual regular-octagon shape, and two (four at just one location) of a total of twelve fusing terminal cases 140 are disposed between each pair of adjacent screw boss parts.

The fusing terminal cases 140 are arranged equispaced in the circumferential direction. One slot is located inward of each fusing terminal case 140 in the radial direction.

Each circular-cylindrical-shaped coil 112 is formed by winding a winding wire around one of the tooth-covering parts 132 of the stator-core assembly 110. The corresponding tooth 126 and the tooth-covering part 132 are disposed in the interior of each coil 112.

The twelve coils 112 are wired in a delta configuration (three phases) as three groups, each group having four of the coils 112. In each group of four coils 112, two of the coils 112 are serially connected and the other two of the coils 112 are likewise serially connected, and both series are connected in parallel (i.e., a 2-series/2-parallel configuration).

The twelve coils 112 described above are formed by two conducting wires, each being one series.

That is, from the start of a first turn, a first conducting wire crosses one of the fusing terminal cases 140, is wound around two of the tooth-covering parts 132, crosses the next fusing terminal case 140, is wound around two of the tooth-covering parts 132, further crosses the next fusing terminal case 140, and crosses the initial fusing terminal case 140, thereby reaching the end of the first turn. A coil-connecting conducting wire (not shown) is formed between the coils 112.

In addition, a second conducting wire is wound in the same manner as the first conducting wire, from the start of a second turn to the end of the second turn. However, it passes through the fusing terminal cases 140 and the tooth-covering parts 132 not passed through by the first conducting wire.

The portion of the conducting wire that continues to the portion of the conducting wire that crossed the fusing terminal cases 140 is first led into the slot and wound one turn around the tooth-covering part 132 (first turn). Continuing, subsequent to a second turn of the conducting wire, the conducting wire is wound such that it follows the first turn or the previous turn. Thus, the conducting wire wound to a prescribed turn forms the coil 112 around the tooth-covering part 132.

The terminal unit 114 comprises: a terminal-unit main body 150, which is made of an electrically insulating resin and has a ring shape having an inner hole; and a plurality of (e.g., three) sheet-metal members 152, which are made of an electrically conductive metal.

A plurality of (e.g., five) screw holes (not shown), each screw hole having a screw hole in the up-down direction, is formed on a circumferential edge of the terminal-unit main body 150. The screw holes protrude radially outward with respect to other portions and are disposed in correspondence with the screw bosses 138.

Furthermore, a plurality of (e.g., three) screw bosses 154, each screw boss 154 having a screw hole that is open upward, is provided on the terminal-unit main body 150. The screw bosses 154 are disposed on a front part, a rear-left part, and a rear-right part of the terminal-unit main body 150. The screw bosses 154 protrude radially inward with respect to other portions of the terminal-unit main body 150.

In addition, projections (not shown), which project upwardly, are provided on a front-left part and a front-right part of the terminal-unit main body 150. Each projection projects radially inward with respect to other portions of the terminal-unit main body 150.

Each sheet-metal member 152 has a semi-arcuate shape and is a member that is C-shaped in top view.

A plurality of fusing terminals 160, each of which protrudes downward, is provided on each sheet-metal member 152. Each fusing terminal 160 has, at the tip of a folded part, a tip that, in the folded part's initial state (the state prior to fusing), opens downward. It is noted that, in FIGS. 2 and 4, the fusing terminals 160 are shown in the initial state.

In addition, a connecting piece (not shown), which protrudes rearward and has a contact hole, is formed on a rear-end part of each sheet-metal member 152.

The fusing terminals 160 of the sheet-metal members 152 are disposed such that they are shifted from one another in the circumferential direction and are disposed such that they respectively oppose the fusing terminal cases 140.

The terminal unit 114 is formed by embedding and integrally molding the sheet-metal members 152 within the (resin) terminal-unit main body 150.

When molded in the main body 150, the sheet-metal members 152 are arranged in the up-down direction, which is their thickness direction, such that they do not contact one another, and are disposed in a concentric-arc shape.

The fusing terminals 160 of the sheet-metal members 152 and the connecting pieces project out of the terminal-unit main body 150. The connecting pieces are partitioned by partitions (not shown).

In the terminal unit 114, the screw holes are aligned with their corresponding screw bosses 138 and are attached to the upper side of the insulator 122 by inserting screws (not shown) into the screw holes.

At this time, the fusing terminals 160, in their initial state, are inserted into their corresponding fusing terminal cases 140 and thereby surround crossover parts that connect the coils 112. Thereafter, when the fusing terminals 160 are heated by passing an electric current or the like therethrough while the fusing terminals 160 are closed and the crossover parts are sandwiched therebetween, the crossover parts and the fusing terminals 160 corresponding thereto are welded (fused) by thermal clinching (crimping), and thereby the coils 112 are connected to one another in the desired state to form the circuit of the coils 112 in the motor 20.

Furthermore, upper ends of the screw bosses 138 (uppermost part of the insulator 122) project out from an upper surface of the attached terminal unit 114.

The power-supply lines 56 are connected to the connecting pieces of the terminal unit 114 via screw bosses, screws, and a terminal plate, which are not shown.

By using such a connection configuration, the circuit of the coils 112 that includes the controller 18 and the battery-mounting part 16 is formed.

In addition, if the screws are removed, then the power-supply lines 56 can be disconnected from the connecting pieces of the terminal unit 114 in a manner such that they can be reconnected.

The sensor circuit board 116 is a ring-shaped board and has an outer diameter that fits within the radially inner side of the inner hole of the terminal-unit main body 150.

A plurality of (e.g., three) rotation-detection devices (not shown), which detect the position of the rotor 52 and output rotation-detection signals, is mounted on the sensor circuit board 116.

The sensor circuit board 116 has a plurality of screw holes. The screw holes are disposed such that they correspond to the screw bosses 154 of the terminal-unit main body 150.

In addition, the sensor circuit board 116 has pin holes (not shown) on the left and right of a front part. The pin holes are disposed such that they correspond to the projections of the projections of the terminal-unit main body 150.

Furthermore, a left-rear side of the sensor circuit board 116 is formed as a straight line that extends in a diagonal direction, and the plurality of signal lines 57, which respectively transmit the rotation-detection signals of the rotation-detection devices, is connected to the inner side thereof via a connector (not shown). If the connector is disconnected, then the signal lines 57 are detached from the sensor circuit board 116 in a manner such that they can be reconnected.

The sensor circuit board 116 is attached to the terminal unit 114 by overlapping the screw holes with the screw bosses 154 of the terminal unit 114 and then inserting screws 162 from above. The sensor circuit board 116 is positioned with respect to the terminal unit 114 by the projections of the projections corresponding to the terminal unit 114 being inserted in the pin holes of the sensor circuit board 116.

On the other hand, the rotor 52 of the motor 20 comprises: a circular-cylindrical-shaped rotor core 170, which is integrally mounted on the center part of the motor shaft 22 such that the rotor core 170 is concentric with the motor shaft 22; and plate-shaped permanent magnets 172, which are disposed inside a plurality of (e.g., eight) magnet holes 171 that are arranged in a concentric circle and pass through a circumferential edge part of the rotor core 170 in the up-down direction.

The rotation-detection devices of the sensor circuit board 116 are magnetic sensors (Hall-effect devices) that detect the positions of the permanent magnets 172 by their magnetism. It is noted that the rotation-detection devices may detect the rotational position of the rotor 52 by means other than magnetism.

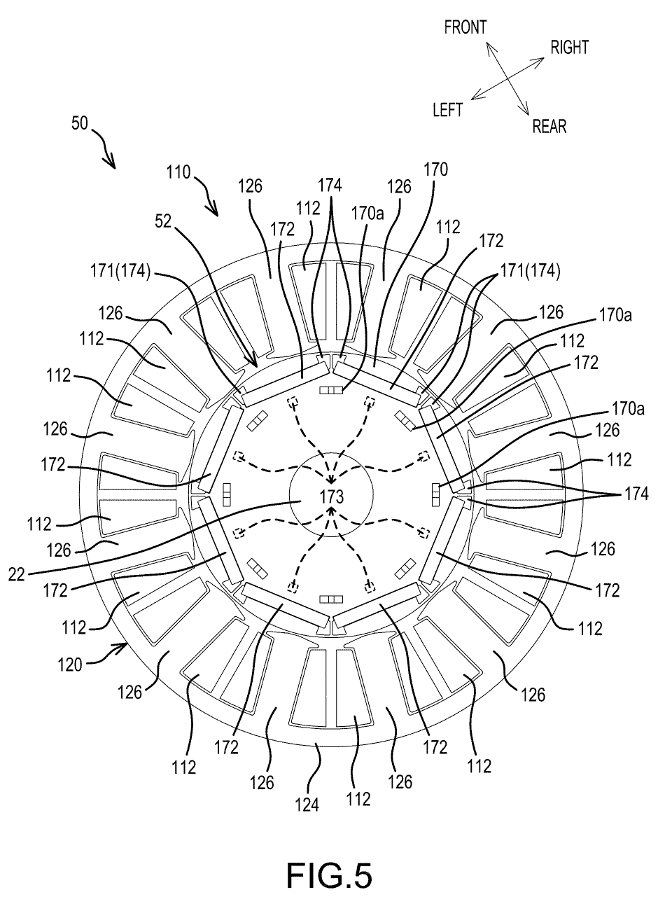

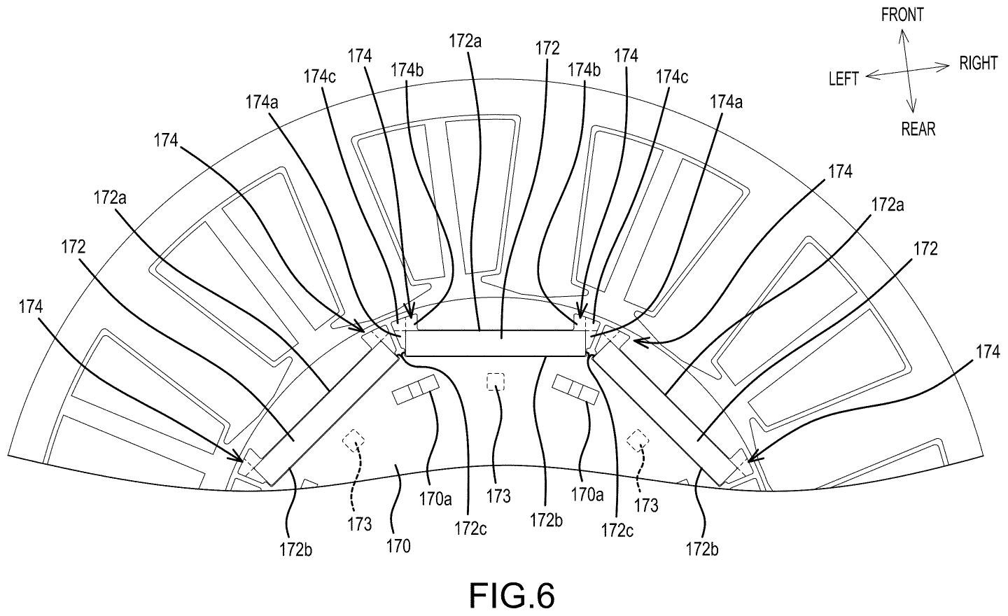

The rotor core 170 is a laminated body in which a plurality of steel plates is laminated. Referring now to FIGS. 5 and 6, each steel plate has a clinching (crimping) part 170a that joins that steel plate to its adjacent steel plates by clinching (crimping). It is noted that the rotor core 170 may have a circular-column shape and may be integral with the motor shaft 22, or may have a prism shape or a polygonal-tube shape.

In addition, the rotor core 170 comprises phase-detection holes 173, which are rectangular in cross section and are respectively disposed radially inward of the center parts of the magnet holes 171. Some of the phase-detection holes 173 may extend downward from an upper surface of the rotor core 170 and some of the phase-detection holes 173 may extend upward from a lower surface of the rotor core 170. The phase-detection holes 173 are formed by forming rectangular holes in several steel plates of the rotor core 170 from above and several steel plates of the rotor core 170 from below, and then layering these steel plates such that holes are not formed in the other steel plates. It is noted that the phase-detection holes 173 may be located in other portions of the rotor core 170, and the phase-detection holes 173 need not correspond in number to the eight magnet holes 171; for example, a total of four of the phase-detection holes 173 may be provided, one phase-detection hole 173 for every other magnet hole 171. In addition, the phase-detection holes 173 may be provided only above or only below, may be through holes, or may be some other shape.

The permanent magnets 172 are arranged in a regular octagonal-cylinder shape overall and are slightly spaced apart from one another in the circumferential direction. The permanent magnets 172 are inserted into the corresponding magnet holes 171 such that the permanent magnets 172 extend in the axial direction (the up-down direction) and the circumferential direction of the rotor core 170. Each permanent magnet 172 has: an outer-side surface 172a, which is the radial outer-side surface of the rotor core 170 and extends in the up-down direction (i.e. the axial direction of the motor) and the circumferential direction; an inner-side surface 172b, which is radial inner-side surface and extends in the up-down direction and the circumferential direction; and a pair of end surfaces 172c, which extend in the radial direction and the up-down direction.

Between adjacent permanent magnets 172 in the circumferential direction, flux barriers 174, which are apertures that protrude beyond the end parts of the permanent magnets 172 from the outer sides in the circumferential direction and the outer sides in the radial direction, are formed at (in) both ends of each magnet hole 171. It is noted that the flux barriers 174 may be formed in only some of the magnet holes 171 and not in the others. In addition, the flux barriers 174 may be formed only at one end of each magnet hole 171 and not at the other end.

Each flux barrier 174 is continuous with the main concave portion (recess) of the magnet hole 171, through which the corresponding permanent magnet 172 passes, and is part of (continuous with) that magnet hole 171.

Each flux barrier 174 has a thick L shape in cross section and comprises: a side part 174a, which extends outward in the circumferential direction from an approximately ⅔ portion of the outer side of the end surface 172c of the corresponding permanent magnet 172 in the radial direction; an outer-circumference side part 174b, which extends radially outward from a circumferentially-extending end portion of the outer-side surface 172a of the corresponding permanent magnet 172; and a connecting part 174c, which connects the side part 174a and the outer-circumference side part 174b. The side part 174a and the connecting part 174c form an end-part aperture, which is an aperture in the circumferential direction that directly-faces or adjoins the end surface 172c of the inserted permanent magnet 172.

A corner portion formed by the outer-side surface 172a and the adjacent end surface 172c of each permanent magnet 172 is exposed to the corresponding flux barrier 174.

To successively insert the permanent magnets 172 into the magnet holes 171 of the rotor core 170 with the desired orientation (such that the poles of the permanent magnets 172 are oriented in accordance with the location of the magnet holes 171) when the rotor 52 is being manufactured, it is necessary to compute the rotational phase (the rotational position) of the rotor core 170.

In this regard, conventionally, the rotational phase of a rotor core is detected by sensing clinching (crimping) parts of the rotor core using a sensor. In this case, there is a possibility that at least one of the shape and the location of the clinching parts will change relative to other portions of the rotor core, depending on the clinched state of the steel plates, and thereby affect the rotational phase that is detected.

In contrast, in the rotor core 170 according to the present teachings, the rotational phase is detected by sensing the phase-detection holes 173 using the sensors. In this case, the possibility that the phase-detection holes 173 will change their shape or location due to the clinching state is low compared with the clinching parts, and therefore the detection of the rotational phase is more immutable. Thereby, it is easier to insert the permanent magnets 172 into the magnet holes 171 of the rotor core 170.

In addition, to fix the permanent magnets 172 to the rotor core 170 using an adhesive (bonding material) and thereby bond the permanent magnets 172 to the rotor core 170, the permanent magnets 172 are successively inserted into their corresponding magnet holes 171 after the adhesive has been introduced into the magnet holes 171 of the rotor core 170. At that time, because the flux barriers 174 of the rotor core 170 include the outer-circumference side parts 174b, which extend radially outward from the outer-side surfaces 172a of the permanent magnets 172, the adhesive easily spreads across the outer-side surfaces 172a of the permanent magnets 172, and a comparatively large amount of the adhesive uniformly fills the outer-circumference side parts 174b of the flux barriers 174. Thereby, by virtue of the permanent magnets 172 being securely (extensively, widely) bonded at (on) their outer-side surfaces 172a, the permanent magnets 172 are much affixed more robustly within the magnet holes 171.

Likewise, even if the permanent magnets 172 and the rotor core 170 are bonded by fixing the permanent magnets 172 to the rotor core 170 using a resin (bonding material), the rotor core 170 is introduced into a mold after the permanent magnets 172 have been inserted into the magnet holes 171, and the resin that is injected into the mold also spreads through the outer-circumference side parts 174b, which extend toward the outer-circumference side of the rotor core 170, of the flux barriers 174, and therefore the resin fills the outer-circumference side parts 174b of the flux barriers 174 comparatively uniformly. Thus, by virtue of the permanent magnets 172 being uniformly bonded with the resin even at (on) their outer-side surfaces 172a of the permanent magnets 172 in the radial direction, the permanent magnets 172 are affixed more robustly within the magnet holes 171.

Furthermore, because the flux barriers 174 are apertures, through (across) which the passage of magnetic fluxes is impeded even when the flux barriers 174 contain the bonding material, and because the flux barriers 174 include the outer-circumference side parts 174b that are nearer to the center part sides of the permanent magnets 172 than are the side parts 174a and the connecting parts 174c and abut the circumferentially-extending end portions of the permanent magnets 172, directionality is imparted to the magnetic fluxes of the permanent magnets 172.

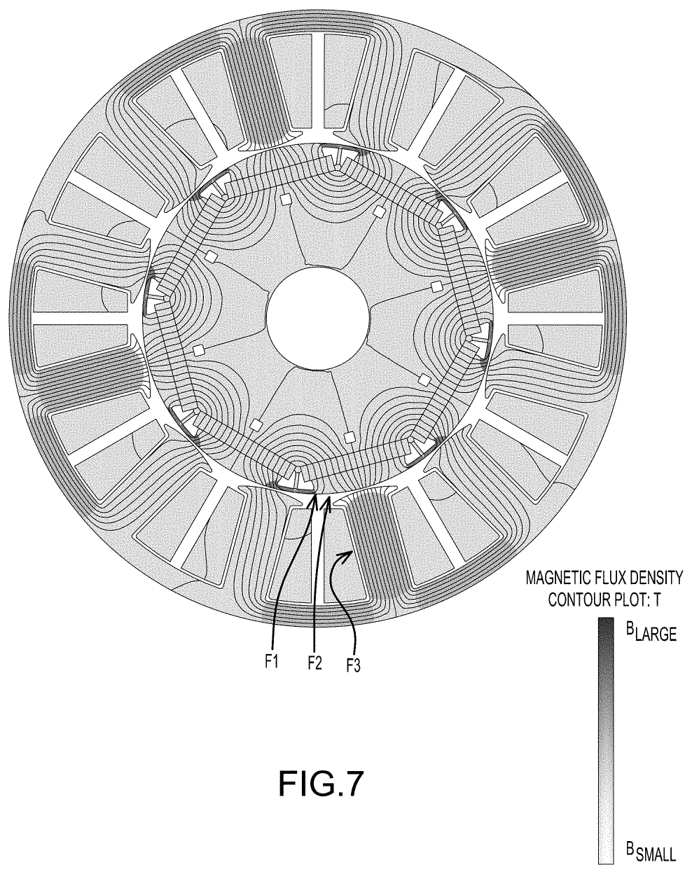

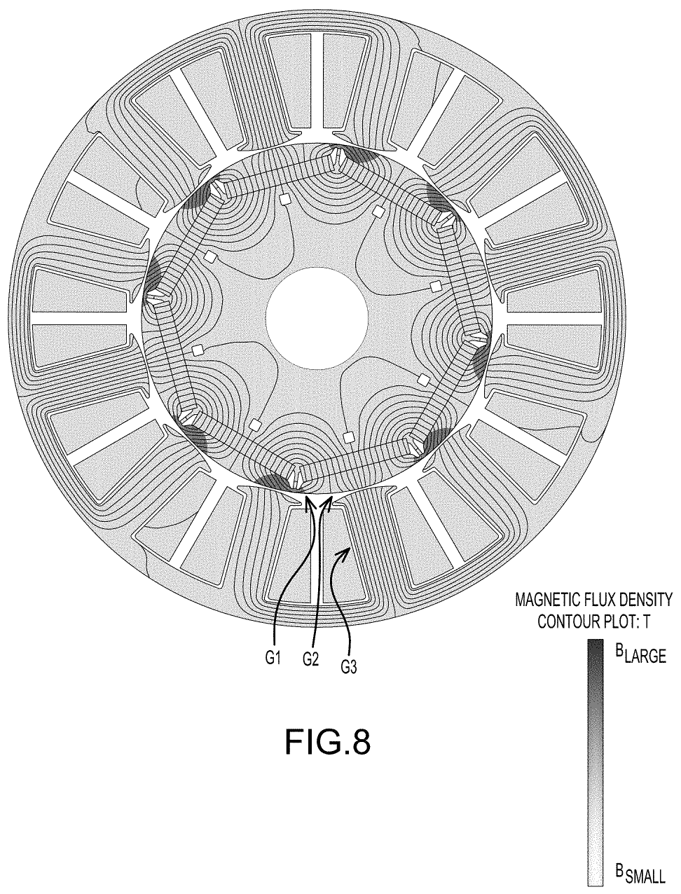

FIG. 7 is a view that shows schematic magnetic-flux lines (contour plot of the magnetic-flux-density contour lines) and the magnitude (color darkness) of magnetic-flux density B at the instant when four teeth 126, one each on the front, rear, left, and right, and every other permanent magnet 172 oppose one another. FIG. 8 is a view that shows, in a comparative example wherein flux barriers are not provided with the outer-circumference side parts 174b, schematic magnetic-flux lines and the magnitude of the magnetic-flux density B. In FIG. 8, the locations (rotational positions) of the teeth and the permanent magnets are the same as in FIG. 7.

Compared with the rotor shown in FIG. 8, the rotor 52 shown in FIG. 7 includes the outer-circumference side parts 174b. Consequently, the magnetic-flux lines that pass through the radially outer-side surfaces 172a of the permanent magnets 172 opposing the teeth 126 (the coils 112) wrap around less toward the adjacent permanent magnets 172 (refer to arrow F1 in FIG. 7 and arrow G1 in FIG. 8) and are oriented such that they extend radially outward (refer to arrow F2 in FIG. 7 and arrow G2 in FIG. 8). It is noted that, if the outer-circumference side parts 174b were to be (hypothetically) disposed instead at the centers of the permanent magnets 172 in the circumferential direction, then the effect of orienting the magnetic fluxes of the permanent magnets 172 would be reduced and the magnetic fluxes leading to the teeth 126 (the coils 112) would be impeded, whereby motor efficiency would be reduced.

Thus, if the magnetic-flux lines are oriented (e.g., primarily) radially outward, then the magnetic fluxes of the permanent magnets 172 are used in the stator 50 with little loss, and therefore the rotor 52 rotates with good efficiency. In the rotor 52 according to FIG. 7, the color (shading) of the teeth 126 respectively opposing the permanent magnets 172 is darker than the color (shading) of the same teeth in FIG. 8 according to the comparative example. This means that the magnetic-flux density of the teeth 126 of the rotor 52 of FIG. 7 is higher (greater) than in the comparative example (refer to arrow F3 in FIG. 7 and arrow G3 in FIG. 8).

Next, an operative example of a lawn mower 1 having such a motor 50 will be explained.

If the user pulls the switch lever 32 after having pressed the lock-off button 36 while two of the charged battery packs 14 are mounted on the battery-mounting part 16, then the main switch turns ON and an ON signal is transmitted to the controller 18 (the control circuit board 42). It is noted that the ON signal optionally may be transmitted even if only one of the battery packs 14 is mounted.

Upon receiving the ON signal, the controller 18 obtains the rotational state of the rotor 52 of the motor 20 by using the microcontroller to obtain the rotation-detection signals of the sensor circuit board 116 via the signal lines 57, and causes the rotor 52 to rotate by controlling the ON/OFF states of the switching devices in accordance with the obtained rotational state so as to cause excitation currents to successively flow through the power-supply lines 56 to each phase of the coils 112 of the stator 50.

Due to the rotation of the rotor 52, the motor shaft 22 rotates. The rotation of the motor shaft 22 is transmitted to the spindle 26, and thereby a rotational force is imparted to the cutting blade 30, which is mounted on the spindle 26. The lawn mower 1 (rotary-blade type) performs the operation of mowing a lawn by rotating the cutting blade 30 horizontally (parallel to the ground) about its axis in the up-down direction.

By pressing the handle 4 frontward, the user causes the lawn mower 1 to travel, via the wheels 12, along the ground, on which grass is growing, and thereby to evenly cut the grass and thus trim the lawn.

Now, non-limiting features, functions and effects exhibited by such a lawn mower 1 will be explained.

The lawn mower 1 comprises the motor 20, which has a circular-column shape and comprises the rotor 52 that is rotatable about its axis. The rotor 52 comprises the plurality of plate-shaped permanent magnets 172, the rotor core 170, which has a circular-cylindrical shape and comprises the plurality of magnet holes 171 into which the permanent magnets 172 are inserted and held so as to extend in the axial direction and the circumferential direction, and bonding material (at least one of adhesive and resin) that bonds the magnet holes 171 and the permanent magnets 172 inserted in the magnet holes 171. Each magnet hole 171 is formed such that the apertures (in particular, the outer-circumference side parts 174b of the apertures 174) are created against (directly facing, adjoining) the radially outer-side surface 172a of the corresponding inserted permanent magnet 172.

Thereby, each permanent magnet 172 is robustly fixed by the bonding material, which uniformly remains in the outer-circumference side part 174b of the corresponding flux barrier 174 that contacts the radially outer-side surface 172a. Accordingly, a lawn mower 1 is provided in which the permanent magnets 172 are reliably prevented from shifting or detaching, and durable operation is possible.

In addition, the apertures (in particular, the outer-circumference side parts 174b) are disposed such that they are respectively adjacent to (directly-face, adjoin) the circumferentially-extending end portions of the radially outer-side surface 172a of the permanent magnet 172 (the pair of axially extending portions on the opposite ends of the outer-side surface 172a). Thereby, a lawn mower 1 is provided in which directionality is imparted to the magnetic fluxes of the permanent magnets 172, the rotor 52 rotates with good efficiency, and operation with good efficiency is possible.

Furthermore, the apertures (in particular, the outer-circumference side parts 174b) extend in the axial direction of the rotor core 170 and penetrate through the rotor core 170. Thereby, a lawn mower 1 is provided in which the adhesive or the resin makes contact with the entirety of the permanent magnets 172 in the axial direction, the permanent magnets 172 are even more reliably prevented from shifting or detaching, and durable operation is possible.

In addition, each magnet hole 171 is formed such that the end-part apertures (in particular, the side part 174a and the connecting part 174c of the aperture 174), which respectively directly face or adjoin each of the end surfaces 172c of each inserted permanent magnet 172, are created, and the above-described apertures directly facing the surface 172a of the permanent magnet 172 (i.e. the outer-circumference side parts 174b) are in series (integral) with the end-part apertures (i.e. the side part 174a and the connecting part 174c of the aperture 174). Thereby, the end-part apertures (i.e. the side part 174a and the connecting part 174c) for reducing wraparound of the magnetic flux and the apertures (i.e. the outer-circumference side parts 174b) for reliable fixing of the permanent magnet 172 are provided in a simple manner. In addition, in each permanent magnet 172, because the two end surfaces 172c and the radially outer-side surface 172a that intersects with the two end surfaces 172c widely or extensively contact the adhesive or the resin, the permanent magnet 172 is affixed more robustly. Accordingly, a lawn mower 1 is provided in which the permanent magnets 172 are more reliably prevented from shifting and detaching, and durable operation is possible.

It is noted that the present teachings are not limited to the first embodiment and its modified examples described above; for example, the following kinds of modification may be further implemented as appropriate.

Each magnet hole 171 may be formed such that one or more apertures (inner-circumferential side parts of the flux barriers 174) are created against (directly facing, adjoining) the radially inner-side surface 172b of each of the inserted permanent magnets 172; that is, such apertures (inner-circumferential side parts) may be provided on the radially inner-side (inward) of the permanent magnet 172 such that the apertures are adjacent to (directly-face or adjoin) the inner-side surface 172b. In this case, too, the functions and effects of the securely affixing the permanent magnets 172 to the rotor core 170 are obtained. In addition, multiple apertures may be provided such that they are adjacent to (adjoin) both the radially outer-side (outward) surface(s) 172a and the radially inner-side (inward) surface(s) 172b (the outer-circumference side parts 174b and inner-circumferential side parts (not shown)) of one or more of the permanent magnets 172.

The apertures may be provided in only some of the magnet holes 171 and not others.

The bonding material may be constituted of something other than adhesive or resin.

The bonding material may be omitted and the permanent magnets 172 may instead be fixed by crimping or the like. Even in this case, the functions and effects of the sufficient orientation of the permanent magnets 172 can be obtained by the apertures (the outer-circumference side parts 174b) being disposed such that they are adjacent to (directly facing, adjoining) the circumferentially-extending end portions of the radially outer-side surfaces 172a of the permanent magnets 172.

The configuration of the housings may be variously modified, for example, any two or more of the main body housing 10, the motor housing 60, and the spindle housing 66 may be integrated, any of the housings may be further subdivided, or the like.

The detachable connection of the power-supply lines 56 can be achieved, instead of using screw locks or in combination therewith, by providing a tab (a connecting projection) and a tab receptacle (a connected part).

The sensor circuit board 116 may be mounted on the insulator 122 instead of the terminal unit 114. In addition, the sensor circuit board 116 may be mounted on both the terminal unit 114 and the insulator 122.

The insulator 122 may have a plurality of discrete, but affixed/joined portions instead of being integral, i.e. formed without seams.

At least one of the power-supply lines 56, the conducting wires forming the coils 112, the signal lines 57, and other lead wires may be a wire in which a plurality of short wires are electrically connected; for example, the coil-connecting conducting wire may be a lead wire separate from the coils 112, and the lead wire and the coils 112 may be electrically connected to one another.

The number, presence/absence, material, structure, and/or type of the various members and portions may be modified as appropriate, for example: instead of the battery-mounting part 16, a power-supply cord may be provided and electrical power may be supplied by a commercial (e.g., AC) power supply; the number of the coils 112, the number of the fusing terminals 160, and/or the number of the power-supply lines 56 may be increased or decreased; grooves that guide the conducting wires of the coils 112 may be provided such that they make one revolution around the bases of the tooth-covering parts 132; the grooves may be fewer in number or shorter; the number of the various screws and screw holes may be increased or decreased; the number of at least one of the projections and the holes of the terminal unit 114 may be increased or decreased; the number of the engagement parts (pins), which engage with the stator core 120 of the terminal unit 114, may be increased or decreased; the engagement of the engagement parts and the engaged parts may be accomplished by the insertion of ribs between the pairs of projections; at least one of the other engagement parts, connecting parts, screw locking parts, holding parts, and mounting parts may be modified to some other structure or type; and the like.

Furthermore, the present teachings may be adapted to a lawn mower of some other type, and in turn some other electric work machine or the like, such as a reel-blade type lawn mower in which the cutting blade 30 is a circular-cylindrical-shaped reel blade in which the left-right direction serves as the axial direction, and the cutting blade 30 rotates thereabout. For example, the present teachings can be adapted to high-power products (e.g., outdoor power equipment) and can also be adapted to: power tools, such as chain saws, blowers, and grinders; gardening tools, such as mowing machines and hedge clippers; and air compressors for pneumatic tools that are powered by air. As in air compressors for pneumatic tools, electrically driven equipment for operating work machines that perform work are included in electric work machines.

The effects of the present teachings described above are exhibited particularly remarkably in comparatively large brushless motors (wherein the outer diameter (diameter) of the stator core 120 is, for example, 80 mm or greater).

### Second Embodiment

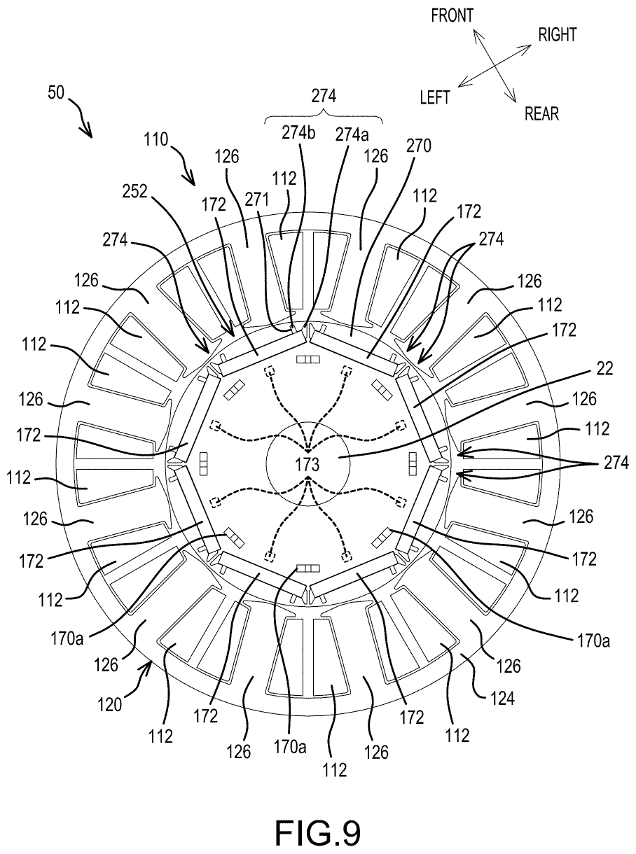

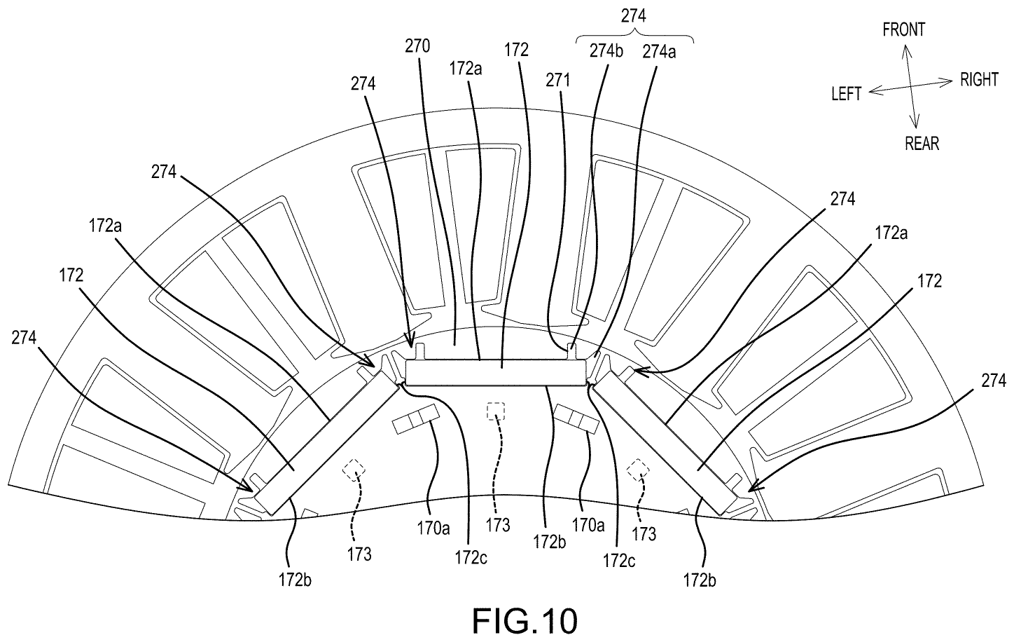

FIG. 9 is a view, corresponding to FIG. 5, of the motor 50 of a lawn mower according to a second embodiment of the present teachings. FIG. 10 is a view, corresponding to FIG. 6, of the motor 50 of the lawn mower according to the second embodiment of the present teachings.

The lawn mower according to the second embodiment is constituted in the same manner as the first embodiment, except for the magnet holes (the flux barriers) of the rotor. Members and portions that are the same as or equivalent to those described in the first embodiment are assigned the same symbols in the drawings, and explanations thereof are omitted as appropriate.

Magnet holes 271 of a rotor core 270 of a rotor 252 according to the second embodiment are each formed such that two apertures 274a, 274b, which are independent from one another, are created against (directly-facing, adjoining) each of the end-edge portions composed of an end portion of the radial outer-side surface 172a and the end surface 172c, which respectively extend in the circumferential direction and the axial direction of the corresponding inserted permanent magnet 172. That is, each flux barrier 274 is composed of these two apertures 274a, 274b, namely a side part 274a, which is similar to the entirety of the side part 174a and a portion of the connecting part 174c of the first embodiment, and an outer-circumferential side part 274b, which is spaced apart from the side part 274a, is adjacent to (adjoins) the end-edge portion of the circumferentially-extending radially outer-side surface 172a, and is rectangular in cross section.

Each side part 274a extends diagonally outward in the circumferential and radial directions from the end surface 172c of the corresponding permanent magnet 172 and does not extend towards the permanent magnet 172 side from the end surface 172c and a virtual extension plane thereof.

Each outer-circumferential side part 274b penetrates through the rotor core 270 and has a groove shape that extends in the axial direction.

To fix the permanent magnets 172 to the rotor core 270 using an adhesive (bonding material) and thereby bond the permanent magnets 172 to the rotor core 270 when the rotor 252 is being manufactured, the permanent magnets 172 are successively inserted into their corresponding magnet holes 271 after the adhesive has been introduced into the magnet holes 271 of the rotor core 270. At that time, because the flux barriers 274 of the rotor core 270 include the outer-circumference side parts 274b, which extend radially outward from the radial outer-side surfaces 172a of the permanent magnets 172, the adhesive easily spreads across the outer-side surfaces 172a of the permanent magnets 172, and a comparatively large amount of the adhesive uniformly fills the outer-circumference side parts 274b of the flux barriers 274. Thereby, by virtue of the permanent magnets 172 being securely bonded at (on) their radially outer-side surfaces 172a, the permanent magnets 172 are much affixed more robustly within the magnet holes 271.

Likewise, even if the permanent magnets 172 and the rotor core 270 are bonded by fixing the permanent magnets 172 to the rotor core 270 using a resin (bonding material), the rotor core 270 is introduced into a mold after the permanent magnets 172 have been inserted into the magnet holes 271, and the resin that is injected into the mold also spreads through (along) the outer-circumference side parts 274b, which extend toward the outer-circumference side of the rotor core 270, of the flux barriers 274, and therefore the resin fills the outer-circumference side parts 274b of the flux barriers 274 comparatively uniformly. Thus, by virtue of the permanent magnets 172 uniformly contacting the resin even at (on) their radially outer-side surfaces 172a, the permanent magnets 172 are affixed more robustly within the magnet holes 271.

Furthermore, because the flux barriers 274 are apertures, through (across) which the passage of magnetic fluxes is impeded, and have outer-circumference side parts 274b that are nearer to the center part sides of the permanent magnets 172 than are the side parts 274a and abut the end portions of the permanent magnets 172 in the circumferential direction, directionality is imparted to the magnetic fluxes of the permanent magnets 172.

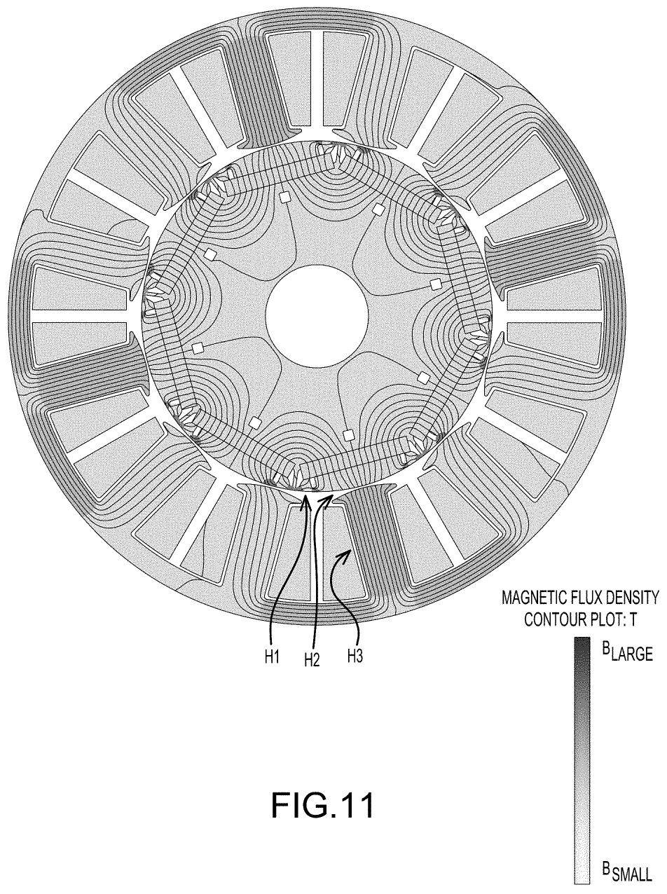

FIG. 11 is a view that shows the schematic magnetic-flux lines and the magnitude of the magnetic-flux density B in the motor 50 of the lawn mower according to the second embodiment of the present teachings.

Because the rotor 252, which has the flux barriers 274, includes the outer-circumference side parts 274b, the magnetic-flux lines that pass through the outer-side surfaces 172a of the permanent magnets 172 opposing the teeth 126 (the coils 112) wrap around less toward the adjacent permanent magnets 172 (refer to arrow H1 in FIG. 11) and are oriented such that they extend radially outward (refer to arrow H2 in FIG. 11). It is noted that, if the outer-circumference side parts 274b were to be (hypothetically) disposed instead at the centers of the permanent magnets 172 in the circumferential direction, then the effect of orienting the magnetic fluxes of the permanent magnets 172 would be reduced and the magnetic fluxes leading to the teeth 126 (the coils 112) would be impeded, whereby motor efficiency would be reduced.

Thus, if the magnetic-flux lines are oriented radially outward, then the magnetic fluxes of the permanent magnets 172 are used in the stator 50 with little loss, and therefore the rotor 252 rotates with good efficiency. In the rotor 252 according to FIG. 11, the color (shading) of the teeth 126 respectively opposing the permanent magnets 172 is darker than the color (shading) of the same teeth in FIG. 8 according to the comparative example, and the magnetic-flux density of the teeth 126 is higher (greater) than in the comparative example (refer to arrow H3 in FIG. 11).

The lawn mower according to the second embodiment comprises a motor, which has a circular-column shape and comprises the rotor 252 that is rotatable about its axis. The rotor 252 comprises: the plurality of plate-shaped permanent magnets 172, the rotor core 270, which has a circular-cylindrical shape and comprises the plurality of magnet holes 271 into which the permanent magnets 172 are inserted so that they extend in the axial direction and the circumferential direction, and bonding material (at least one of adhesive and resin) that bonds the magnet holes 271 and the permanent magnets 172 inserted in the magnet holes 271. Each magnet hole 271 is formed such that the apertures (in particular, the outer-circumference side parts 274b) are created against (directly-facing, adjoining) the radially outer-side surface 172a of the corresponding inserted permanent magnet 172.

Thereby, each permanent magnet 172 is securely fixed by the bonding material, which uniformly remains in the outer-circumference side part 274b of the corresponding flux barrier 274 that contacts the outer-side surface 172a. Accordingly, a lawn mower is provided in which the permanent magnets 172 are reliably prevented from shifting or detaching, and durable operation is possible.

In addition, the apertures (in particular, the outer-circumference side parts 274b) are disposed such that they are respectively adjacent to (directly-face, adjoin) the circumferentially-extending end portions of the radially outer-side surface 172a of the permanent magnet 172 (the pair of axially extending portions on the opposite ends of the outer-side surface 172a). Thereby, a lawn mower is provided in which directionality is imparted to the magnetic fluxes of the permanent magnets 172, the rotor 252 rotates with good efficiency, and operation with good efficiency is possible.

Furthermore, the apertures (in particular, the outer-circumferential side parts 274b) each have a groove shape. Thereby, a lawn mower is provided in which the bonding material easily spread throughout, the permanent magnets 172 are further prevented from shifting or detaching, and durable operation is possible.

Furthermore, the apertures (in particular, the outer-circumference side parts 274b) extend in the axial direction of the rotor core 270 and penetrate through the rotor core 270. Thereby, a lawn mower is provided in which the bonding material makes contact with the entirety of the permanent magnets 172 in the axial direction, the permanent magnets 172 are even more reliably prevented from shifting or detaching, and durable operation is possible.

It is noted that the same modified examples in the first embodiment apply, as appropriate, to the second embodiment.

In particular, instead of the outer-circumferential side parts 274b or in combination therewith, apertures (inner-circumferential side parts) having a groove-shaped, rectangular cross section may be provided against (directly-facing, adjoining) the radially inner-side surface 172b of one or more of the permanent magnets 172. In addition, although at least one of the outer-circumferential side parts 274b and the inner-circumferential side parts may be provided, a plurality of them may be provided at (adjacent, adjoining) one end portion of the permanent magnet 172 in the circumferential direction. Furthermore, the outer-circumferential side part 274b of the second embodiment may be provided, in combination, with the flux barrier 174 of the first embodiment.

### Third Embodiment

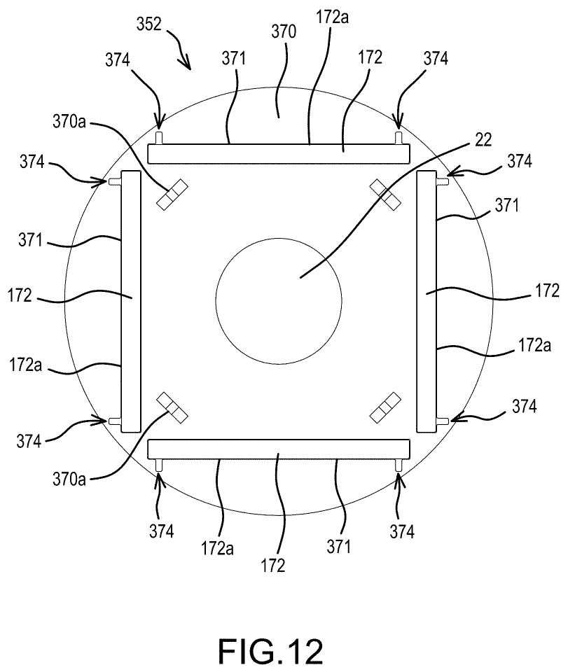

FIG. 12 is a center transverse-cross-sectional view of the rotor of the motor of the lawn mower according to a third embodiment of the present teachings.

The lawn mower according to the third embodiment is constituted the same as in the second embodiment, except for the rotor core, the permanent magnets, and the magnet holes. Members and portions that are the same as or equivalent to those described in the second embodiment are assigned the same symbols in the drawings, and explanations thereof are omitted as appropriate.

Four magnet holes 371, four clinching (crimping) parts 370a, and four permanent magnets 172 of a rotor core 370 of a rotor 352 according to the third embodiment are arranged such that they are square-shaped in top view.

The magnet holes 371 are each formed such that apertures (flux barriers 374), which are independent from one another, are created against (directly-facing, adjoining) the circumferentially-extending, end-edge portions of the outer-side surface 172a, which extends in the circumferential direction and the axial direction, of the corresponding permanent magnet 172 inserted therein. That is, the flux barriers 374 are respectively adjacent to (directly-facing, adjoin) the circumferentially-extending, end-edge portions of the outer-side surface 172a, are rectangular in cross section, and have the same shape as the outer-circumferential side parts 274b of the flux barriers 374 of the second embodiment.

Each flux barrier 374 penetrates through the rotor core 370 and has a groove shape that extends in the axial direction.

To fix the permanent magnets 172 to the rotor core 370 using an adhesive (bonding material) and thereby bond the permanent magnets 172 to the rotor core 370 when the rotor 352 is being manufactured, the permanent magnets 172 are successively inserted into their corresponding magnet holes 371 after the adhesive has been introduced into the magnet holes 371 of the rotor core 370. At that time, because the flux barriers 374 of the rotor core 370 extend radially outward from the radially outer-side surfaces 172a of the permanent magnets 172, the adhesive easily spreads across the outer-side surfaces 172a of the permanent magnets 172, and a comparatively large amount of the adhesive uniformly fills the flux barriers 374. Thereby, by virtue of the permanent magnets 172 being securely bonded at their outer-side surfaces 172a, the permanent magnets 172 are much affixed more robustly within the magnet holes 371.

Likewise, even if the permanent magnets 172 and the rotor core 370 are bonded by fixing the permanent magnets 172 to the rotor core 370 using a resin (bonding material), the rotor core 370 is introduced into a mold after the permanent magnets 172 have been inserted into the magnet holes 371, and the resin that is injected into the mold also spreads through the flux barriers 374, and therefore the resin fills the flux barriers 374 comparatively uniformly. Thus, by virtue of the permanent magnets 172 reliably contacting the resin, the permanent magnets 172 are affixed more robustly within the magnet holes 371.

Furthermore, because the flux barriers 374 are apertures, through (across) which the passage of magnetic fluxes is impeded, and abut the circumferentially-extending end portions of the permanent magnets 172, directionality is imparted to the magnetic fluxes of the permanent magnets 172, the same as in the second embodiment.

Thus, if the magnetic-flux lines are oriented radially outward, then the magnetic fluxes of the permanent magnets 172 are used in the stator with little loss, and therefore the rotor 352 rotates with good efficiency.

The lawn mower according to the third embodiment comprises a motor, which has a circular-column shape and comprises the rotor 352 that is rotatable about its axis. The rotor 352 comprises: the plurality of plate-shaped permanent magnets 172, the rotor core 370, which has a circular-cylindrical shape and comprises the plurality of magnet holes 371 into which the permanent magnets 172 are inserted so that they extend in the axial direction and the circumferential direction, and bonding material (at least one of adhesive and resin) that bonds the magnet holes 371 and the permanent magnets 172 inserted in the magnet holes 371. Each magnet hole 371 is formed such that the apertures (the flux barriers 374) are created against (directly-face, adjoin) the radially outer-side surface 172a of the corresponding inserted permanent magnet 172.

Thereby, each permanent magnet 172 is securely fixed by the bonding material, which uniformly remains in the flux barriers 374 that contact the outer-side surface 172a thereof. Accordingly, a lawn mower is provided in which the permanent magnets 172 are reliably prevented from shifting or detaching, and durable operation is possible.

In addition, the apertures (the flux barriers 374) are disposed such that they are adjacent to (directly-face, adjoin) the circumferentially-extending end portions of the radially outer-side surface 172a of each of the permanent magnets 172 (the pair of axially extending portions on the opposite ends of the outer-side surface 172a). Thereby, a lawn mower is provided in which directionality is imparted to the magnetic fluxes of the permanent magnets 172, the rotor 352 rotates with good efficiency, and operation with good efficiency is possible.

Furthermore, the apertures (the flux barriers 374) each have a groove shape. Thereby, a lawn mower is provided in which the bonding material easily spreads throughout, the permanent magnets 172 are further prevented from shifting or detaching, and durable operation is possible.

Furthermore, the apertures (the flux barriers 374) extend in the axial direction of the rotor core 370 and penetrate through the rotor core 370. Thereby, a lawn mower is provided in which the bonding material makes contact with the entirety of the permanent magnets 172 in the axial direction, the permanent magnets 172 are even more reliably prevented from shifting or detaching, and durable operation is possible.

It is noted that the same modified examples in the second embodiment apply, as appropriate, to the third embodiment.

In particular, instead of the flux barriers 374 or in combination therewith, apertures (inner-circumferential side parts) having a groove-shaped, rectangular cross section may be provided against (directly-facing, adjoining) the radially inner-side surface 172b of the permanent magnet 172. In addition, the flux barrier 374 may comprise the side parts 274a of the second embodiment. Furthermore, although at least one of the flux barrier 374 and the inner-circumferential side part may be provided, a plurality of them may be provided at (adjacent, adjoining) one end portion of the permanent magnet 172 in the circumferential direction.

Additional embodiments of the present teachings include, but are not limited to:

1. An electric work machine comprising:

a motor comprising a rotor, which has a columnar or a tube shape and is rotatable about its axis;

wherein the rotor comprises:
a plurality of plate-shaped permanent magnets;
a rotor core, which is columnar or tubular and has a plurality of magnet holes into which the permanent magnets are inserted in the state in which the permanent magnets extend in an axial direction and a circumferential direction; and
bonding material, which bonds the magnet holes and the permanent magnets inserted into those magnet holes; and

wherein at least one of the magnet holes is formed such that an aperture is created against at least one of a radially outer-side surface and a radially inner-side surface of the corresponding inserted permanent magnet.

2. An electric work machine comprising:

a motor comprising a rotor, which has a columnar or a tube shape and is rotatable about its axis;

wherein the rotor comprises:
a plurality of plate-shaped permanent magnets; and
a rotor core, which is columnar or tubular and has a plurality of magnet holes into which the permanent magnets are inserted in the state in which the permanent magnets extend in an axial direction and a circumferential direction; and

wherein at least one of the magnet holes is formed such that an aperture is created against a radially outer-side surface of the corresponding inserted permanent magnet.

3. The electric work machine according to the above embodiment 2, wherein the aperture is disposed such that it is adjacent to (adjoins) a circumferential-direction end portion of the permanent magnet.

4. The electric work machine according to any one of the above embodiments 1-3, wherein the aperture has a groove shape.

5. The electric work machine according to any one of the above embodiments 1-4, wherein the aperture extends in the axial direction of the rotor core and penetrates through the rotor core.

6. The electric work machine according to any one of the above embodiments 1-5, wherein:

at least one of the magnet holes is formed such that an end-part aperture, which is an aperture against a circumferential-direction end surface of the corresponding inserted permanent magnet, is created; and

the above-mentioned aperture is in series with the above-mentioned end-part aperture.

Any of the apertures 174b, 274b, 374 that directly-face or adjoin the radially outer-side (outward) surface 172a of the permanent magnet 172 preferably have at least one straight side that extends perpendicular to the radially outer-side (outward) surface 172a. Preferably, such apertures 274b, 374 have two straight, parallel sides that extend perpendicular to the radially outer-side (outward) surface 172a. In this case, the apertures 274b, 374 have a substantially rectangular shape in transverse cross-section, although the end of the aperture 274b, 374 that is opposite of the radially outer-side (outward) surface 172a may have a curved shape. However, the radially-extending sides of the apertures (i.e. the sides that extend perpendicular from the radially outer-side surface 172a) may also be slightly inclined or oblique relative to each other and thus, instead of being parallel, may form an angle of, for example, 1, 2, 3, 4, 5, 6, 7, 8, 9 or 10 degrees, wherein each of the mentioned values can also be an upper or lower limit of a range defined thereby, such as, e.g., a range of 2-7 degrees.

The apertures 174b, 274b, 374 that directly-face or adjoin the radially outer-side (outward) surface 172a of the permanent magnet 172 preferably have a depth (i.e. the distance from the adjoin the radially outer-side (outward) surface 172a to the base or opposite (radially-outward) end of the apertures 174b, 274b, 374) of, for example, 1, 2, 3, 4, 5, 6, 7, 8, 9 or 10 mm, wherein each of the mentioned values can also be an upper or lower limit of a range defined thereby, such as, e.g., a range of 2-6 mm.

The apertures 174b, 274b, 374 that directly-face or adjoin the radially outer-side (outward) surface 172a of the permanent magnet 172 preferably have a width (i.e. the distance from side to side of the aperture 174b, 274b, 374 in the direction parallel to the radial outer-side surface 172a) of, for example, 0.5, 1, 2, 3, 4, 5, 6, 7, 8, 9 or 10 mm, wherein each of the mentioned values can also be an upper or lower limit of a range defined thereby, such as, e.g., a range of 1-4 mm.

The apertures 174b, 274b, 374 that directly-face or adjoin the radially outer-side (outward) surface 172a of the permanent magnet 172 preferably have an aspect ratio (i.e. depth to width ratio) of, for example, 2, 3, 4, 5, 6, 7 or 8, wherein each of the mentioned values can also be an upper or lower limit of a range defined thereby, such as, e.g., a range of 3-5.

The apertures 174b, 274b, 374 that directly-face or adjoin the radially outer-side (outward) surface 172a of the permanent magnet 172 may directly-face or adjoin the end part 172c, such as aperture 174b, or may be spaced apart from the end part 172c so as to not directly-face adjoin the end part 172c, such as apertures 274b and 374. The centers of the apertures 274b, 374 that do not directly-face or adjoin the end parts 172c are preferably located at a position along the radially outer-side surface 172a that is spaced from the end part 172c by a distance that is, e.g., 5%, 10%, 15%, 20%, 25%, 30%, 35% or 40% of the total length of the radially outer-side surface 172a in the circumferential direction, wherein each of the mentioned values can also be an upper or lower limit of a range defined thereby, such as, e.g., a range of 5-25% of the total length of the radially outer-side surface 172a in the circumferential direction.

Finally, it is noted that the terms “circumferential direction” and “circumferentially-extending” have been used to describe, e.g., the extension direction of the radially outer-side surface 172a. However, as is clear from the drawings, the radially outer-side surface 172a is not curved, but rather is flat or straight. Therefore, the terms “circumferential direction” and “circumferentially-extending” should be understood as encompassing the meaning of tangential direction or tangentially-extending, wherein the radially outer-side surfaces 172a extend at a tangent to a circle that circumscribes the center points of each of the permanent magnets 172, or extend parallel to a tangent of the outer circumference of the stator core 120.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric motors.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Lawn mower (gardening tool, electric work machine)
20 Motor
52, 252 Rotor
170, 270, 370 Rotor core
171, 271, 371 Magnet hole
172 Permanent magnets
172a Outer-side surface (of permanent magnet)
172c End surface (of permanent magnet)
174, 274, 374 Flux barrier
174a, 274a Side part (end-part aperture) (of flux barrier)
174b, 274b Outer-circumference side part (aperture) (of flux barrier)
174c Connecting part (end-part aperture) (of flux barrier)

1. An electric work machine comprising:
a motor comprising a rotor, which has a columnar or a tube shape and is rotatable about its axis;
wherein the rotor comprises:
a plurality of plate-shaped permanent magnets; and
a rotor core, which is columnar or tubular and has a plurality of magnet holes into which the permanent magnets are respectively inserted such that the permanent magnets extend in an axial direction and a circumferential direction of the rotor; and
wherein a surface of at least one of the magnet holes includes at least one aperture that directly-faces or adjoins a radially outer-side surface of the corresponding inserted permanent magnet.

2. The electric work machine according to claim 1, wherein the at least one aperture is disposed such that it directly-faces or adjoins a circumferentially-extending end portion of the radially outer-side surface.

3. The electric work machine according to claim 2, wherein the at least one aperture has a groove shape.

4. The electric work machine according to claim 3, wherein the at least one aperture extends in the axial direction of the rotor core and penetrates through the rotor core.

5. The electric work machine according to claim 4, wherein the surface of the at least one of the magnet holes further includes an end-part aperture that directly-faces or adjoins an end surface of the corresponding inserted permanent magnet.

6. The electric work machine according to claim 5, wherein the at least one aperture is in series or integral with the end-part aperture.

7. The electric work machine according to claim 1, wherein the at least one aperture has a groove shape.

8. The electric work machine according to claim 1, wherein the at least one aperture extends in the axial direction of the rotor core and penetrates through the rotor core.

9. The electric work machine according to claim 1, wherein the surface of the at least one of the magnet holes further includes an end-part aperture that directly-faces or adjoins an end surface of the corresponding inserted permanent magnet.

10. The electric work machine according to claim 9, wherein the at least one aperture is in series or integral with the end-part aperture.

11. An electric work machine comprising:
a motor comprising a rotor, which has a columnar or a tube shape and is rotatable about its axis;
wherein the rotor comprises:
a plurality of plate-shaped permanent magnets;
a rotor core, which is columnar or tubular and has a plurality of magnet holes into which the permanent magnets are respectively inserted such that the permanent magnets extend in an axial direction and a circumferential direction of the rotor; and
bonding material, which bonds the magnet holes and the permanent magnets respectively inserted into the magnet holes; and
wherein a surface of at least one of the magnet holes includes at least one aperture that directly-faces or adjoins at least one of a radially outer-side surface and a radially inner-side surface of the corresponding inserted permanent magnet.

12. The electric work machine according to claim 11, wherein the at least one aperture has a groove shape.

13. The electric work machine according to claim 12, wherein the at least one aperture extends in the axial direction of the rotor core and penetrates through the rotor core.

14. The electric work machine according to claim 13, wherein the surface of the at least one of the magnet holes further includes an end-part aperture that directly-faces or adjoins an end surface of the corresponding inserted permanent magnet.

15. The electric work machine according to claim 14, wherein the at least one aperture is in series or integral with the end-part aperture.

16. The electric work machine according to claim 11, wherein the at least one aperture has a groove shape.

17. The electric work machine according to claim 11, wherein the at least one aperture extends in the axial direction of the rotor core and penetrates through the rotor core.

18. The electric work machine according to claim 11, wherein the surface of the at least one of the magnet holes further includes an end-part aperture that directly-faces or adjoins an end surface of the corresponding inserted permanent magnet.

19. The electric work machine according to claim 18, wherein the at least one aperture is in series or integral with the end-part aperture.

20. An electric work machine comprising:
a motor comprising a rotor, which has a columnar or a tube shape and is rotatable about its axis;
wherein the rotor comprises:
a plurality of plate-shaped permanent magnets;
a rotor core, which is columnar or tubular and has a plurality of magnet holes into which the permanent magnets are respectively inserted such that the permanent magnets extend in an axial direction and a circumferential direction of the rotor; and
bonding material, which bonds the magnet holes and the permanent magnets respectively inserted into the magnet holes; and
wherein:
a surface of at least one of the magnet holes includes at least one aperture that directly-faces or adjoins at least one of a radially outer-side surface and a radially inner-side surface of the corresponding inserted permanent magnet; and
the at least one aperture modifies a directionality of magnetic flux of the corresponding inserted permanent magnet.
